(19) United States
(12) Patent Application Publication
(10) Pub. No.: US 2009/0108038 A1
(43) Pub. Date: Apr. 30, 2009

(54) Removal trash receptable for use in a vehicle

(76) Inventor: Michael Palmisano, Methuen, MA (US)

Correspondence Address: LAMBERT & ASSOCIATES, P.L.L.C., 92 STATE STREET, BOSTON, MA, 02109-2004, US

(21) Appl. No.: 12/286,628

(22) Filed: Oct. 1, 2008

Related U.S. Application Data
(60) Provisional application No. 61/000,249, filed on Oct. 25, 2007.

(51) Int. Cl. B60R 7/00

(52) U.S. Cl. 224/280

(57) ABSTRACT

A removable trash receptacle for placement within a vehicle, preferably under the center console, such that the receptacle is held in place by the tension the receptacle created against the center console, thereby allowing for a convenient means of disposing trash generated within a vehicle.

### CROSS REFERENCE TO RELATED APPLICATION

This application claims the benefit of U.S. Provisional Patent Application Ser. No. 61/000,249 filed on Oct. 25, 2007.

### BACKGROUND OF THE INVENTION

1. Field of the Invention

The instant invention relates generally to the field of trash receptacles and more particularly to a flexible and removable trash receptacle that is placeable under a center console of a vehicle.

2. Description of the Related Art

U.S. Pat. No. 6,874,836 to Feser discloses a covered trash receptacle system for vehicles such as golf carts. The system typically includes a main body having a hollow interior into which trash can be placed. The main body includes a lid connected to the main body with a hinge system that prevents the lid from opening past a certain point so that the system can be operated and emptied with one hand.

U.S. Pat. No. 7,217,078 to Short discloses a vehicle mounted carrier for lifting and securing a waste receptacle or other articles for transport.

U.S. Pat. No. 5,226,576 to Ellsworth discloses a waste receptacle with an outer container having foldable sidewalls, a rectangular bottom and an inner means for supporting and securing a disposable bag liner.

U.S. Pat. No. 6,705,690 to O'Brien discloses a trash receptacle device having a pair of railings, wherein the railings contain open sides that face each other. Each of the railing is mountable to a bottom wall of the glove compartment.

U.S. Pat. No. 3,916,639 to Atkins discloses an automobile accessory comprised of a chest of insulated material having an upper end closed by a removable lid wherein the chest has an inclined forward wall so as to fit partly beneath the vehicle dashboard.

U.S. Pat. No. 5,031,808 to Dolenc discloses a receptacle for the collection of litter or the storage of loose items in a vehicle interior.

U.S. Pat. No. 6,676,362 to Pickering discloses a vehicle trash compactor for keeping the passenger compartment neat and clean by allowing the user to comfortably compact the trash in the vehicle.

### SUMMARY OF THE INVENTION

The instant invention, as illustrated herein, is clearly not anticipated, rendered obvious, or even present in any of the prior art mechanisms, either alone or in any combination thereof.

The primary object of the present invention is to provide a trash receptacle, preferably for use in a vehicle, so that individuals have a convenient way of discarding trash and other items.

Another object of the present invention is to provide a trash receptacle, preferably for use in a vehicle, wherein the placement of the receptacle does not interfere with individuals entering and exiting the vehicle.

Another object of the present invention is to provide a trash receptacle, preferably for use in a vehicle, wherein the receptacle is situated under the center console and held in place by the tension placed on the center console from the top sides of the receptacle.

Another object of the present invention is to provide a trash receptacle, preferably for use in a vehicle, wherein the receptacle is within the reach of a driver, without interfering with the dashboard storage compartments.

There has thus been outlined, rather broadly, the more important features of the removable trash receptacle in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 illustrates an isometric view of the instant invention, illustrating the overall trash receptacle prior to placement in a vehicle.

FIG. 2A illustrates a top perspective view of the instant invention, wherein the receptacle is in the closed position under the center console of a vehicle.

FIG. 2B illustrates a side perspective view of the instant invention, wherein the receptacle is in the closed position under the center console of a vehicle.

FIG. 3A illustrates a top perspective view of the instant invention, wherein the receptacle is in the open position under the center console of a vehicle.

FIG. 3B illustrates a side perspective view of the instant invention, wherein the receptacle is in the open position under the center console of a vehicle.

### DETAILED DESCRIPTION OF THE PREFERRED EMBODIMENT

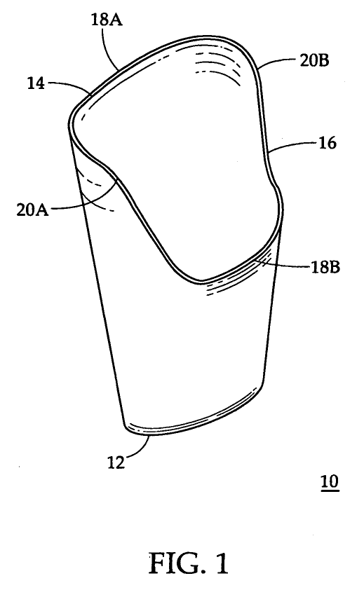

FIG. 1 illustrates a removable trash receptacle 10 that is preferably substantially conical in shape and modifiable to fit the contours of a vehicle having a center console, preferably for use in vehicles manufactured by American Honda Motor Company Incorporated. The receptacle 10 includes a base 12 that is preferably circular in nature and a top 14 that is open, wherein the circumference of the base 12 is preferably smaller than the circumference of the top 14 such that volume of the receptacle 10 increases from the base 12 to the top 14. The receptacle 10 further includes a cut-away area 16 comprising a profile tapered to allow mating with the center console, preferably in a Honda Odyssey. The cut-away area 16 in the receptacle 10 creates a first side 18A and a second side 18B, wherein both the first and second side 18A and 18B are situatable in the parallel direction. In addition, a first end 20A and a second end 20B are situatable in the parallel direction to each other, and are situatable in the perpendicular direction to the first and second side 18A and 18B such that the slope running from the first side 18A to the second side 18B by both first and second ends 20A and 20B is preferably in the range of forty-five to sixty degrees.

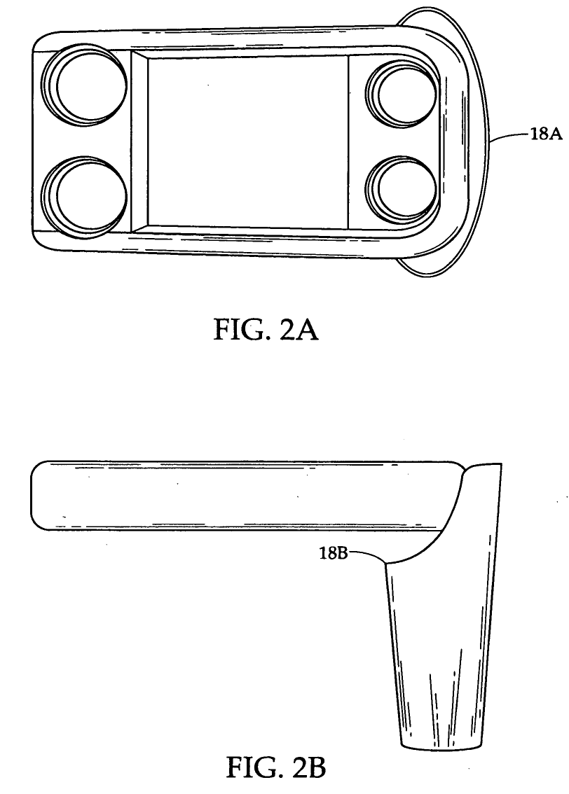

FIG. 2A and FIG. 2B illustrate the receptacle 10 in use in the closed position wherein the cut-away area 16 preferably mates with the center console locatable in a vehicle, preferably a make and model such as the Honda Odyssey. In this position, the receptacle 10 is placeable in an inconspicuous area so as not to interfere with the normal driver/passenger traffic flow in and out of the vehicle. Therefore, when the receptacle 10 is in the closed position, it does not interfere with a vehicle's seat pockets or any dashboard storage compartments located in the vehicle. The receptacle 10 is held in place and in the closed position by the flexible tension placed on the center console of the vehicle from the first and second end 20A and 20B of the receptacle. Preferably there is a small gap between the bottom of the center console and the second side 18B of the receptacle.

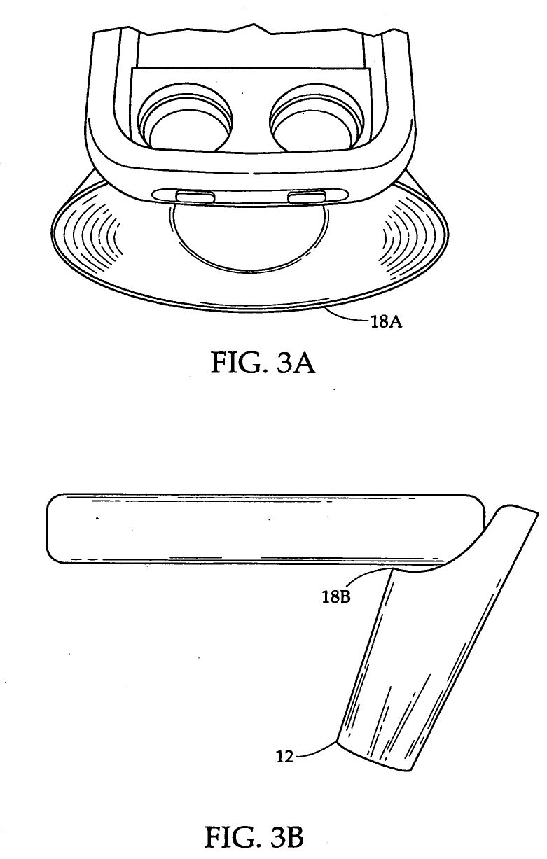

FIG. 3A and 3B illustrate the receptacle 10 in use in the open position wherein the receptacle is able to accept trash or other items that an individual desires to remove from the vehicle. The receptacle 10 transitions from the closed position by an individual pushing back on the first side 18A of the receptacle to allow for the receptacle 10 to tilt in the backward direction away from the center console until the second side 18B engages the bottom of the console. Thus the friction created by the second side being engaged with the bottom of the center console, not only provides sufficient tension to the hold the receptacle in the open position, but also acts as a stop point for the open position of the receptacle 10. Once the receptacle 10 has reached its maximum open position, preferably the angle of tilt is in the range of twenty to thirty degrees. In an alternate embodiment, preferably the tilt angle is approximately twenty seven degrees.

In yet another alternate embodiment, the instant invention operates in conjunction with a bump or raised cleat that is installed as part of the vehicle flooring such that the base of the instant invention engages the bump or cleat to allow it to hold the position of the pivot point during operation of the instant invention transitioning from a closed to open position and vice versa.

I claim:

1. A vehicle trash receptacle comprising:
a substantially conical shape;
a base; and
a top.

2. The trash receptacle of claim 1 wherein the receptacle is modifiable to fit the contours of a vehicle having a center console.

3. The trash receptacle of claim 1 wherein the base is substantially circular in nature.

4. The trash receptacle of claim 1 wherein the top is substantially open.

5. The trash receptacle of claim 1 wherein the circumference of the base is substantially smaller than the circumference of the top such that the volume of the receptacle increases from the base to the top.

6. The trash receptacle of claim 1 further comprising:
a cut-away area comprising a profile tapered to allow mating with the center console.

7. The trash receptacle of claim 6 wherein the cut-away area further includes a first side and a second side, and wherein the first and second sides are situatable in a parallel direction.

8. The trash receptacle of claim 7 wherein the cut-away area further includes a first end and a second end, and wherein the first and second ends are situatable in a parallel direction.

9. The trash receptacle of claim 8 wherein the first and second sides are situatable in a perpendicular direction to the first and second ends.

10. The trash receptacle of claim 9 wherein a slope running from the first side to the second side by both the first and second ends is preferably in the range of forty-five to sixty degrees.

11. The trash receptacle of claim 10 wherein the receptacle is preferably for use with a vehicle made by American Honda Motor Company Incorporated.

12. The trash receptacle of claim 11 wherein the cut-away area preferably mates with the center console in the vehicle such that the receptacle is held in place by the flexible tension placeable on the center console by the first side.

13. The trash receptacle of claim 12 wherein the receptacle is able to tilt in the backward direction to accept trash, such that the receptacle is held in position by the friction when the second side engages the bottom of the console.

14. The trash receptacle of claim 6 wherein the tilt angle is preferably in the range of twenty to thirty degrees.

15. The trash receptacle of claim 6 wherein the tilt angle is twenty seven degrees.
